(19) United States
(12) Patent Application Publication
(10) Pub. No.: US 2006/0048446 A1
(43) Pub. Date: Mar. 9, 2006

(54) Pellet of plant seed, a method of pelletization and a cultivation method of plants using the same

(76) Inventor: Seung-Hyun Kim, Gangwon-do (KR)

Correspondence Address: NATH & ASSOCIATES, 112 South West Street, Alexandria, VA, 22314, US

(21) Appl. No.: 10/532,642

(22) PCT Filed: Sep. 16, 2003
(86) PCT No.: PCT/KR03/01892

§ 371 Date: Apr. 25, 2005

(30) Foreign Application Priority Data
Oct. 28, 2002 (KR) 10-2002-0065848

(51) Int. Cl. A01C 1/06

(52) U.S. Cl. 47/57.6

(57) ABSTRACT

The present invention relates to a pelletization method of plant seed by mixing fertilizer, plant growth regulator, bactericide and insecticide with peatmoss, forming and drying said mixture, inserting the plant seed into it, pressing and sealing those and then obtaining the resulted pellet with plant seed. The present invention makes it possible to provide a pellet with plant seed being great in plant growing after germination by preventing physiological reaction of seed from removal of water. Also, the present invention can be us ed for bulbous plants and is not necessary to cover with earth on those after sowing seeds in a soil surface.

### TECHNICAL FIELD

The present invention relates to a pellet of plant seed, a pelletization method and a cultivation method of plants using the same. More particularly, it relates to the pelletization method of plant seed by forming to insert a plant seed in that by using peatmoss, drying the formed mixture and inserting the plant seed into it, the pellet with plant seed prepared by said method and the cultivation method of plants by sowing the pellet with plant seed in a soil surface.

### BACKGROUND ART

Sowing and a cultivation of plant seed have been developed through research to many steps, but there are still problems to be solved. The cultivation of plants comprises many steps such as sowing, raising seedling, fertilization and controlling noxious insects and needs many labors, costs and times. Also, it needs a scientific and an experiential knowledge for treatment of plant seed.

A peatmoss often used in the technical field of the present invention is an organic material that is pile of rotten reeds of swamp or marsh in a cold region. The peatmoss has 15 times of moisture absorption compared with dry condition and an excellent aeration. In addition, it is light and has no side effect such as chemical reaction on fertilization, so it is generally used in sowing plant seed, production of seedling and cultivation.

On the other hand, in the technical field of the present invention, a pellet is prepared by coating surface of plant seed with a mixture comprising nutrients for germination and growth promotion of plant seed. An object of the pelletization is an enlargement for mechanization of micro-seed and a protection from harmful insect or bacteria for germination promotion and seedling. In the prior art, a pellet of plant seed was generally prepared by coating surface of plant seed with treated material severally. The pellet with plant seed prepared by said method is not effective. In addition, it has an economical problem and troublesomeness because the material for pelletization does not function as soil, so it is necessary to cover with earth again after sowing seed.

Also, the peatmoss used as a material for pelletization reduces labors and times to cover with soil again because it functions as soil. However, addition of water happens in the pelletization process, the water is absorbed into the seed and expands germ and endosperm. Finally the seed coat is exploded and germinated. Drying in the process of storage after those physiological activation makes the seed to be happened a physiological impediment to effect germination in the sowing, as a result of that, germination rate drops. Therefore, the removal of water is a technical subject in the pelletization process using peatmoss.

To solve said problem in the prior art, it has been used a method which is coated surface of plant seed with materials comprising mud, phosphate powder, lime powder and water-soluble Arabic gum severally by glue and dried. However, the method could not be used to all kinds of seed, especially bulbous plants, because materials for growth such as fertilizer for growth, plant growth regulator, bactericide and insecticide are not together with smoothly.

In order to solve the problem for removal of water from the pellet, as mentioned hereinabove, the present invention prepared a pellet with plant seed by pressing and forming from using peatmoss and plant growth regulator etc., drying the formed mixture, making a hole to it, inserting a plant seed into it and sealing them. Accordingly, an object of the present invention is to provide the pelletization method of plant seed. Another object of the present invention is to provide pellet of plant seed obtained by said pelletization method. A further object of the present invention is to provide the cultivation method of plant using said pellet with plant seed.

### DISCLOSURE OF THE INVENTION

The present invention is achieved by the method as follows; pelleting a plant seed by adding various materials, sowing the pellet with plant seed in various methods and confirming excellent effects of said pellet with plant seed by investigating the germination rate of plant seed, the germination number day by day and the condition of growth.

A pelletization method of plant seed according to the present invention, which comprises the steps of:

a) mixing one or more selected from the group consisting of fertilizer, plant growth regulator, bactericide and insecticide with peatmoss using water-soluble glue;

b) forming a mixture of a) step to insert a plant seed in that;

c) drying the mixture formed from b) step; and

d) making a hole to said dried mixture, inserting the plant seed into it, pressing and sealing them and obtaining the resulted pellet with plant seed inserted.

Hereinafter, the steps of the pelletization method of plant seed according to the present invention will be in detail described in the below.

Step 1

One or more selected from the group consisting of fertilizer, plant growth regulator, bactericide and insecticide are mixed with peatmoss as occasion demands, and water-soluble glue is added to those. The fertilizer comprises N, P and K ingredients. The plant growth regulator comprises plant growth hormone, typically GA and NAA. Water-soluble glue is preferably vegetative cement or can be acryl cement. Peatmoss absorbed water by the mixture and can be pressed under wet condition.

Step 2

The mixture obtained from the above is pressed and formed to insert plant seed. Size and shape of the pellet depends on those of plant seed. The mixture can be pressed and formed by the wet peatmoss and water-soluble glue in the first step. FIG. 11 shows the processes of pelletization according to the present invention.

Step 3

The pressed and formed mixture obtained from the second step is dried at 25˜80° C. At this time, a water content of the mixture is preferably 15˜25% by weight. A drying method in the process of the present invention is preferably a hot wind drying method for mass production or a natural drying method. As the plant seed is inserted after drying, it prevents the germination of plant seed from water absorbed into the peatmoss. Therefore, the problem that is described in the above does not happen.

Step 4

The dried mixture of the above step is made a hole by drill to insert the plant seed in that. Then plant seed is inserted into it, and a inserted hole is pressed and sealed with peatmoss or the mixture of the first step. In the process of the present invention, the drill is used to make a hole, however an device prepared for mass production is used, too.

The pelletization method of plant seed according to the present invention doesn't have incidental chemical reaction during mixing various materials such as fertilizer, plant growth regulator, bactericide and insecticide with peatmoss. In addition, the forming is free and its process is convenient. Also the present invention, the pellet with plant seed doesn't have a physiological reaction by water. Furthermore, the pellet with plant seed, which is sown and is absorbed water, has 3 or 4 times volume than drying condition and can be used in a large-scale cultivation because peatmoss functions as a soil, therefore the pellet can be sown in a soil surface. In addition, said pelletization method can be used to the bulbous plants, which have not tried pelletization of plant seed.

TABLE 1
Comparison of the pelletization between
the present invention and the Prior Art

| | Pelletization method of | Pelletization method of |
|---|---|---|
| | the prior art | the present invention |
| Target | Mainly micro plant seed | All kinds of plant seeds |
| | | and bulbous plants |
| Purpose | Enlargement and | Possibility of |
| | uniformity for | enlargement, uniformity, |
| | mechanization of sowing | simplicity of cultivation |
| | | and flight sowing. |
| Material | Mud, phosphate powder, | Peatmoss |
| | lime powder, water- | |
| | soluble Arabic gum | |
| Preparation | 1) Seed is prepared as | 1) Forming a mixture of |
| and | a pellet by coating | additions and peatmoss, |
| characteristic | materials on its | drying those, making a |
| | surface by using glue | hole to said mixture, |
| | severally. | inserting plant seed into |
| | 2) Expensive | it, and pressing and |
| | manufacturing | sealing. |
| | equipments are needed. | 2) Preparation is very |
| | | easy, simple |
| | | manufacturing equipments |
| | | are needed and it is |
| | | possible to make it by |
| | | hand. |
| Water drying | In the process of | The physiological |
| | coating seed with | activation problem does |
| | various materials, wind | not happen because of |
| | or heat is used for | forming using peatmoss |
| | drying, and the | and inserting the plant |
| | physiological | seed after drying. |
| | activation problem | |
| | happens because of | |
| | water absorption into | |
| | the seed in the | |
| | preparing process. | |
| Addition | It is possible to mix | Such ingredients |
| | materials comprising | necessary for growth of |
| | fertilizer, plant | plant seed as fertilizer, |
| | growth regulator, | plant growth regulator, |
| | bactericide, and | bactericide, and |
| | insecticide, but to be | insecticide are easily |
| | happened inhibition | mixed and there are no |
| | effect by chemical | inhibition effects. |
| | reactions. | |
| Physical and | 1) Aeration and | 1) Aeration and moisture |
| chemical | moisture holding | holding is excellent. |
| characteristic | are not good. | 2) Chemical inhibition |
| | 2) The selection of | reaction does not happen |
| | material needs a | completely. |
| | caution because there | |
| | is a possibility of | |
| | incidental chemical | |
| | reaction by coating | |
| | materials. | |
| Sowing | It is necessary to sow | It is possible to sow |
| method | seed in the soil | seed in the soil surface |
| | because pelletization | as well as in the soil |
| | materials do not | because peatmoss |
| | function as a soil. | functions as a soil. |
| Hereafter | Complement of defects | It is possible to be |
| possibility | is needed according to | applied widely in all |
| | materials and applied | kinds of plant seeds and |
| | plant seed. | bulbous plants. Also it |
| | | can be practiced as soon |
| | | as possible. |

The present invention will be explained in more detail with reference to the below examples and experimental examples. However, it should be understood that the scope of the present invention is not limited thereto.

### BRIEF DESCRIPTION OF THE DRAWINGS

FIG. 1a is a graph that shows a germination rate on the first experiment according to various pelletization methods and sowing methods (experimental examples 1˜8) in Calendula officinalis cv. Gold star seed;

FIG. 1b is a graph that shows a germination rate on the second experiment according to various pelletization methods and sowing methods (experimental examples 1˜8) in Calendula officinalis cv. Gold star seed;

FIG. 2a is a graph that shows a germination rate on the first experiment according to various pelletization methods and sowing methods (experimental examples 1˜8) in Salvia splendens cv. Hot jazz seed;

FIG. 2b is a graph that shows a germination rate on the second experiment according to various pelletization methods and sowing methods (experimental examples 1˜8) in Salvia splendens cv. Hot jazz seed;

FIG. 3 is a graph that shows a germination rate according to various pelletization methods and sowing methods (experimental examples 1˜8) in Glycine max cv. Whanggeum seed;

FIG. 4a is the first experiment graph that shows a change of germination population after sowing according to sowing methods in Calendula officinalis cv. Gold star seed that is not palletized;

FIG. 4b is the first experiment graph that shows a change of germination population after sowing according to sowing methods in Calendula officinalis cv. Gold star seed with fertilizer-treatment only.

FIG. 4c is the first experiment graph that shows a change of germination population after sowing according to sowing methods in Calendula officinalis cv. Gold star seed that is treated with fertilizer and GA;

FIG. 4d is the first experiment graph that shows a change of germination population after sowing according to sowing methods in Calendula officinalis cv. Gold star seed that is treated with fertilizer and NAA;

FIG. 5a is the second experiment graph that shows a change of germination population after sowing according to sowing methods in Calendula officinalis cv. Gold star seed that is not palletized;

FIG. 5b is the second experiment graph that shows a change of germination population after sowing according to sowing methods in Calendula officinalis cv. Gold star seed with fertilizer-treatment only;

FIG. 5c is the second experiment graph that shows a change of germination population after sowing according to sowing methods in Calendula officinalis cv. Gold star seed that is treated with fertilizer and GA;

FIG. 5d is the second experiment graph that shows a change of germination population after sowing according to sowing methods in Calendula officinalis cv. Gold star seed that is treated with fertilizer and NAA;

FIG. 6a is the first experiment graph that shows a change of germination population after sowing according to sowing methods in Salvia splendens cv. Hot jazz seed that is not palletized;

FIG. 6b is the first experiment graph that shows a change of germination population after sowing according to sowing methods in Salvia splendens cv. Hot jazz seed with fertilizer-treatment only;

FIG. 6c is the first experiment graph that shows a change of germination population after sowing according to sowing methods in Salvia splendens cv. Hot jazz seed that is treated with fertilizer and GA;

FIG. 6d is the first experiment graph that shows a change of germination population after sowing according to sowing methods in Salvia splendens cv. Hot jazz seed that is treated with fertilizer and NAA;

FIG. 7a is the second experiment graph that shows a change of germination population after sowing according to sowing methods in Salvia splendens cv. Hot jazz seed that is not palletized;

FIG. 7b is the second experiment graph that shows a change of germination population after sowing according to sowing methods in Salvia splendens cv. Hot jazz seed with fertilizer-treatment only;

FIG. 7c is the second experiment graph that shows a change of germination population after sowing according to sowing methods in Salvia splendens cv. Hot jazz seed that is treated with fertilizer and GA;

FIG. 7d is the second experiment graph that shows a change of germination population after sowing according to sowing methods in Salvia splendens cv. Hot jazz seed that is treated with fertilizer and NAA;

FIG. 8a is an experiment graph that shows a change of germination population after sowing according to sowing methods in Glycine max cv. Whanggeum seed that is not palletized;

FIG. 8b is an experiment graph that shows a change of germination population after sowing according to sowing methods in Glycine max cv. Whanggeum seed with fertilizer-treatment only;

FIG. 8c is an experiment graph that shows a change of germination population after sowing according to sowing methods in Glycine max cv. Whanggeum seed that is treated with fertilizer and GA;

FIG. 8d is an experiment graph that shows a change of germination population after sowing according to sowing methods in Glycine max cv. Whanggeum seed that is treated with fertilizer and NAA;

FIG. 9 is a photograph shows comparison of a pelletization between plant seeds and bulbous plants;

FIG. 10 is a photograph shows a pelletization of plant seed;

FIG. 11 is a photograph shows a sowing state of the pellet with plant seed according to the present invention;

FIG. 12a is a photograph of the first experiment that shows a growth state of the pellet of Calendula officinalis cv. Gold star seed prepared by experimental examples 1˜8 in two months after sowing;

FIG. 12b is a photograph of the second experiment that shows a growth state of the pellet of Calendula officinalis cv. Gold star seed prepared by experimental examples 1˜8 in two months after sowing;

FIG. 13a is a photograph of the first experiment that shows a growth state of the pellet of Salvia splendens cv. Hot jazz seed prepared by experimental examples 1˜8 in two months after sowing;

FIG. 13b is a photograph of the second experiment that shows a growth state of the pellet of Salvia splendens cv. Hot jazz seed prepared by experimental examples 1˜8 in two months after sowing;

FIG. 14 is a photograph of the first experiment that shows a growth state of the pellet of Glycine max cv. Whanggeum seed prepared by experimental examples 1˜8 in two months after sowing;

### DETAILED DESCRIPTION OF THE PREFERRED EMBODIMENTS

To compare and analyze the effect of the pelletization using peatmoss, fertilizer and plant growth regulator, the pellets of Calendula officinalis cv. Gold star, Salvia splendens cv. Hot jazz, and Glycine max cv. Whanggeum seeds were prepared by pelletization method mentioned hereinabove. Then, many growth states comprising germination rate, germination number day by day after sowing, plant height and leaf length were studied, took statistics and analyzed.

The first experiment was carried out from April 2002 to June 2002, and the second experiment was carried out from May 2002 to July 2002. The seeds of Calendula officinalis cv. Gold star and Salvia splendens cv. Hot jazz were carried out the first and the second experiments, and the seed of Glycine max cv. Whanggeum was carried out the first experiment only. The sowing was conducted to a rectangle plastic box for cutting by using clay sand. Intermediate fertilizer was not applied at all, and only watering was carried out as demands. Said processes were carried out 3 times repeatedly to one hundred of every seed.

Also, a planting of the prepared pellet was conducted by two sowing methods; one is a sowing method that is not necessary to cover with earth after sowing seed in the soil surface and the other is a sowing method that is necessary to cover with earth.

A shape of pellet depends on size and shape of plant seed; however, the pellets in the below examples were made to a spherical shape for a convenience of experiment. Pelletization treatment and planting method were carried out as follows.

### EXAMPLE 1

The every seed of Calendula officinalis cv. Gold star, Salvia splendens cv. Hot jazz, and Glycine max cv. Whanggeum was not pelletized and planted by a method sowing seed in the soil surface.

### EXAMPLE 2

Pellets, which were prepared by adding fertilizer ingredients consisting of 300 mg/L of N, 200 mg/L of P and 400 mg/L of K with peatmoss, adjusting as pH 5.8, adding a water-soluble glue, forming said mixture, inserting the Calendula officinalis cv. Gold star, Salvia splendens cv. Hot jazz, and Glycine max cv. Whanggeum seeds into it and then pressing them to a spherical shape were planted by the method sowing seed in the soil surface.

### EXAMPLE 3

Pellets, which were prepared by adding fertilizer ingredients consisting of 300 mg/L of N, 200 mg/L of P and 400 mg/L of K and 300 ppm of GA with peatmoss, adjusting as pH by 5.8, adding a water-soluble glue, forming said mixture, inserting the Calendula officinalis cv. Gold star, Salvia splendens cv. Hot jazz, and Glycine max cv. Whanggeum seeds into it and then pressing them to a spherical shape were planted by the method sowing seed in the soil surface.

### EXAMPLE 4

Pellets, which were prepared by adding fertilizer ingredients consisting of 300 mg/L of N, 200 mg/L of P and 400 mg/L of K and 300 ppm of NAA with peatmoss, adjusting as pH 5.8, adding a water-soluble glue, forming said mixture, inserting the Calendula officinalis cv. Gold star, Salvia splendens cv. Hot jazz, and Glycine max cv. Whanggeum seeds into it and then pressing them to a spherical shape were planted by the method sowing seed in the soil surface.

### EXAMPLE 5

The every seed of Calendula officinalis cv. Gold star, Salvia splendens cv. Hot jazz, and Glycine max cv. Whanggeum was not pelletized and planted by a method sowing seed in the soil.

### EXAMPLE6

Pellets, which were prepared by adding fertilizer ingredients consisting of 300 mg/L of N, 200 mg/L of P and 400 mg/L of K with peatmoss, adjusting as pH 5.8, adding a water-soluble glue, forming said mixture, inserting the Calendula officinalis cv. Gold star, Salvia splendens cv. Hot jazz, and Glycine max cv. Whanggeum seeds into it and then pressing them to a spherical shape were planted by the method sowing seed in the soil.

### EXAMPLE 7

Pellets, which were prepared by adding fertilizer ingredients consisting of 300 mg/L of N, 200 mg/L of P and 400 mg/L of K and 300 ppm of GA with peatmoss, adjusting as pH 5.8, adding a water-soluble glue, forming said mixture, inserting the Calendula officinalis cv. Gold star, Salvia splendens cv. Hot jazz, and Glycine max cv. Whanggeum seeds into it and then pressing them to a spherical shape were planted by the method sowing seed in the soil.

### EXAMPLE 8

Pellets, which were prepared by adding fertilizer ingredients consisting of 300 mg/L of N, 200 mg/L of P and 400 mg/L of K and 300 ppm of NAA with peatmoss, adjusting as pH 5.8, adding a water-soluble glue, forming said mixture, inserting the Calendula officinalis cv. Gold star, Salvia splendens cv. Hot jazz, and Glycine max cv. Whanggeum seeds into it and then pressing them to a spherical shape were planted by the method sowing seed in the soil.

TABLE 2
Preparation of pellet by examples 1˜8

| | | Plant | | | |
|---|---|---|---|---|---|
| | Fertilizer | growth | | | |
| Example | (mg/L) | regulator | Peatmoss | pH | Sowing method |
| 1 | No | No | No | 5.8 | Sowing seed in |
| | | | | | the soil surface |
| 2 | N; 300 | No¹⁾ | Pressing to a | 5.8 | Sowing seed in |
| | P; 200 | | spherical shape | | the soil surface |
| | K; 400 | | after treatment | | |
| 3 | N; 300 | GA²⁾ | Pressing to a | 5.8 | Sowing seed in |
| | P; 200 | 300 ppm | spherical shape | | the soil surface |
| | K; 400 | | after treatment | | |
| 4 | N; 300 | NAA³⁾ | Pressing to a | 5.8 | Sowing seed in |
| | P; 200 | 300 ppm | spherical shape | | the soil surface |
| | K; 400 | | after treatment | | |
| 5 | No | No | No | 5.8 | Sowing seed in |
| | | | | | the soil |
| 6 | N; 300 | No | Pressing to a | 5.8 | Sowing seed in |
| | P; 200 | | spherical shape | | the soil. |
| | K; 400 | | after treatment | | |
| 7 | N; 300 | GA | Pressing to a | 5.8 | Sowing seed in |
| | P; 200 | 300 ppm | spherical shape | | the soil |
| | K; 400 | | after treatment | | |
| 8 | N; 300 | NAA | Pressing to a | 5.8 | Sowing seed in |
| | P; 200 | 300 ppm | spherical shape | | the soil |
| | K; 400 | | after treatment | | |

[Footnote]
¹⁾No; no pelletization
²⁾GA; Giberellin
³⁾NAA; Naphthalene acetic acid

TABLE 3
Growth difference in the pellet of Calendula officinalis
cv. Gold star seed treated by method of examples 1˜8

| | | | | | | | |
|---|---|---|---|---|---|---|---|
| | | Leaf | Leaf | Plant | Root | Fresh | No. |
| | No. | length | width | height | length | weight | of |
| Example | of leaves | (cm) | (cm) | (cm) | (cm) | (g) | flowers |

The first experiment

| | | | | | | | | | |
|---|---|---|---|---|---|---|---|---|---|
| 1 | 5.90 c¹⁾ | 3.36 d | 0.93 d | 7.69 | cd | 6.95 | bc | 1.65 ab | 0.07 ab |
| 2 | 9.12 b | 9.69 a | 2.37 a | 11.82 | b | 9.96 | a | 2.05 a | 0.00 b |
| 3 | 13.02 a | 7.25 b | 1.94 b | 15.92 | a | 7.47 | b | 1.98 ab | 0.00 b |
| 4 | 0.83 e | 0.81 f | 0.23 e | 1.97 | f | 3.07 | e | 1.51 b | 0.14 a |
| 5 | 5.84 c | 4.05 d | 1.54 c | 6.48 | d | 6.13 | cd | 0.15 d | 0.00 b |
| 6 | 6.38 c | 7.61 b | 2.12 ab | 8.95 | c | 7.03 | bc | 1.60 ab | 0.00 b |
| 7 | 8.86 b | 4.95 c | 1.37 c | 8.79 | c | 5.33 | d | 0.67 c | 0.00 b |
| 8 | 2.05 d | 1.51 e | 0.44 e | 4.40 | e | 2.84 | e | 1.80 ab | 0.00 b |

The second experiment

| | | | | | | | | | |
|---|---|---|---|---|---|---|---|---|---|
| 1 | 1.27 d | 1.30 c | 0.41 d | 2.41 | e | 1.30 | d | 0.11 c | 0.00 b |
| 2 | 7.84 a | 6.46 a | 1.55 a | 10.94 | c | 12.40 | a | 3.49 b | 0.00 b |
| 3 | 8.64 a | 6.19 a | 1.82 a | 16.59 | a | 12.36 | a | 3.55 a | 0.02 b |
| 4 | 0.00 e | 0.00 d | 0.00 e | 0.00 | f | 0.00 | d | 0.00 c | 0.00 b |
| 5 | 4.34 c | 4.29 b | 1.01 c | 7.40 | d | 7.23 | c | 0.57 c | 0.00 b |
| 6 | 6.20 b | 5.81 a | 2.15 b | 12.85 | b | 8.36 | c | 2.93 b | 0.05 a |
| 7 | 5.45 b | 6.31 a | 1.59 b | 13.36 | b | 10.66 | b | 2.76 b | 0.00 b |
| 8 | 0.09 e | 0.12 d | 0.01 e | 0.18 | f | 0.10 | d | 0.01 c | 0.00 b |

[Footnote]
¹⁾Mean separation within columns by Duncan's multiple range test at p = 0.05.

TABLE 4
Growth difference in the pellet of Salvia splendens cv.
Hot jazz seed treated by method of examples 1˜8

| | | | | | | | |
|---|---|---|---|---|---|---|---|
| | | Leaf | Leaf | Plant | Root | Fresh | No. |
| | No. of | length | width | height | length | weight | of |
| Example | leaves | (cm) | (cm) | (cm) | (cm) | (g) | flowers |

The first experiment

| | | | | | | | | | |
|---|---|---|---|---|---|---|---|---|---|
| 1 | 0.67 d¹⁾ | 0.25 d | 0.22 c | 2.33 | d | 2.33 | d | 0.57 c | 0.00 b |
| 2 | 7.06 a | 3.95 a | 3.39 a | 19.58 | a | 18.28 | a | 5.94 a | 0.00 b |
| 3 | 5.73 b | 4.26 a | 3.34 a | 18.11 | a | 11.73 | b | 4.95 b | 0.10 a |
| 4 | 3.15 c | 2.00 bc | 1.66 b | 7.80 | b | 5.29 | c | 1.46 c | 0.04 b |
| 5 | 4.96 b | 1.44 cd | 1.30 b | 7.36 | bc | 10.60 | b | 1.07 c | 0.00 b |
| 6 | 2.46 c | 3.16 ab | 1.26 b | 4.62 | cd | 4.88 | c | 1.45 c | 0.00 b |
| 7 | 3.04 c | 1.90 bc | 1.37 b | 5.12 | bcd | 3.88 | cd | 1.13 c | 0.00 b |
| 8 | 1.08 d | 0.67 cd | 0.53 c | 3.41 | d | 2.27 | d | 1.19 c | 0.00 b |

The second experiment

| | | | | | | | | | |
|---|---|---|---|---|---|---|---|---|---|
| 1 | 3.43 c | 1.33 c | 0.81 c | 3.41 | c | 4.92 | c | 0.17 bc | 0.00 b |
| 2 | 1.48 d | 1.03 cd | 0.60 c | 2.69 | c | 1.79 | d | 0.57 b | 0.00 b |
| 3 | 7.14 a | 6.31 a | 2.68 a | 15.46 | a | 12.57 | b | 2.24 a | 0.00 b |
| 4 | 0.00 e | 0.00 d | 0.00 d | 0.00 | d | 0.00 | d | 0.00 c | 0.00 b |
| 5 | 4.60 b | 1.15 cd | 0.61 c | 3.26 | c | 4.79 | c | 0.13 bc | 0.00 b |
| 6 | 0.24 e | 0.25 cd | 0.14 d | 0.18 | d | 0.22 | d | 0.20 bc | 0.02 b |
| 7 | 3.60 c | 3.04 b | 1.80 b | 6.96 | b | 14.64 | a | 2.55 a | 0.24 a |
| 8 | 0.00 e | 0.00 d | 0.00 d | 0.00 | d | 0.00 | d | 0.00 c | 0.00 b |

[Footnote]
¹⁾Mean separation within columns by Duncan's multiple range test at p = 0.05.

TABLE 5
Growth difference in the pellet of Glycine max cv.
Whanggeum seed treated by method of examples 1˜8

| | No. | Leaf | | Leaf | | Plant | Root | Fresh | No. | No. |
|---|---|---|---|---|---|---|---|---|---|---|
| | of | length | | width | | height | length | weight | of | of |
| Example | leaves | (cm) | | (cm) | | (cm) | (cm) | (g) | flowers | pods |
| 1 | 0.81 d¹⁾ | 2.76 | f | 1.81 | f | 6.82 f | 6.08 e | 1.68 b | 0.71 e | 0.00 c |
| 2 | 4.06 bc | 14.64 | b | 9.37 | bc | 47.22 d | 19.24 b | 9.74 b | 2.55 bc | 0.06 c |
| 3 | 4.60 ab | 12.09 | c | 8.58 | bc | 57.52 ab | 14.20 c | 6.57 b | 1.48 d | 0.61 a |
| 4 | 1.27 d | 4.34 | e | 3.06 | e | 11.04 f | 6.87 e | 4.48 b | 0.90 e | 0.06 c |
| 5 | 4.28 bc | 15.61 | b | 12.11 | a | 53.78 bc | 22.94 a | 5.42 b | 2.82 ab | 0.42 ab |
| 6 | 5.07 ab | 17.83 | a | 11.09 | a | 63.95 a | 21.70 ab | 11.00 b | 3.43 a | 0.29 b |
| 7 | 3.47 c | 8.38 | d | 6.13 | d | 47.57 cd | 15.67 c | 3.64 b | 1.60 d | 0.41 b |
| 8 | 3.66 c | 12.63 | c | 7.74 | cd | 37.00 e | 10.33 d | 22.40 a | 2.39 c | 0.48 ab |

[Footnote]
¹⁾Mean separation within columns by Duncan's multiple range test at p = 0.05.

Effects of the pellet with plant seed according to the present invention are as follows;

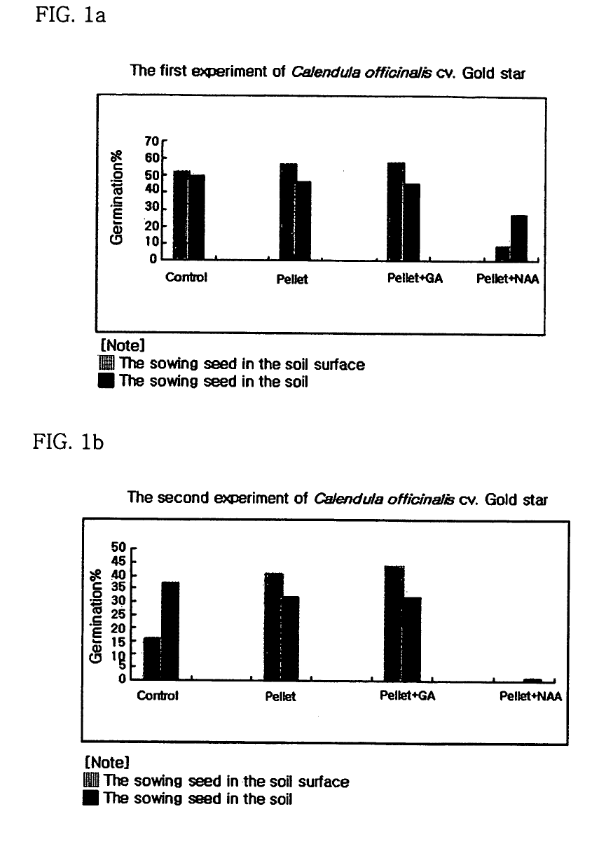

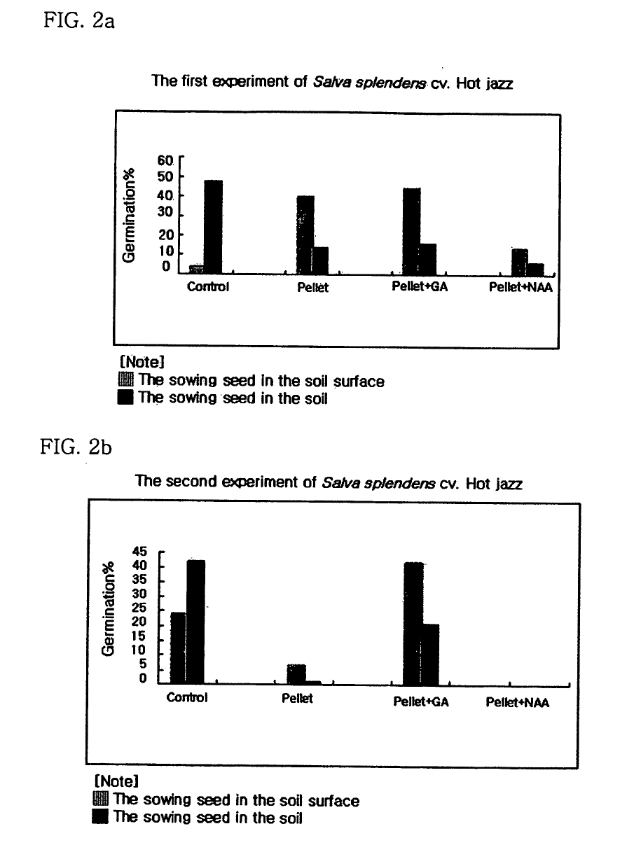

The pelletization treatment for the seeds of Calendula officinalis cv. Gold star, Salvia splendens cv. Hot jazz, and Glycine max cv. Whanggeum resulted in a far better growth than the control in number of leaves, leaf length, leaf width, plant height and root length etc. (Table 3, 4, 5). The germination rate of the palletized seeds was similar to the control (FIG. 1a, 1b, 2a, 2b, 3), however, the pelletization treatment improved the growth state of plant seed after germination than the control because of fertilizing ingredients mixed with peatmoss. Therefore, in the case of Calendula officinalis cv. Gold star, number of leaves and plant height were more than twice than the control (Table 3). Particularly, Glycine max cv. Whanggeum had four times number of leaves and nine times plant height than the control (Table 5). The reason is judged as follows; the peatmoss, which is light and has an excellent aeration, makes oxygen supply necessary for germination smooth, the water potential of said peatmoss that is more than 60% of total volume in the watering or rain makes seed sufficiently wet and an absorption of mixed fertilizer makes nutrient supply smooth.

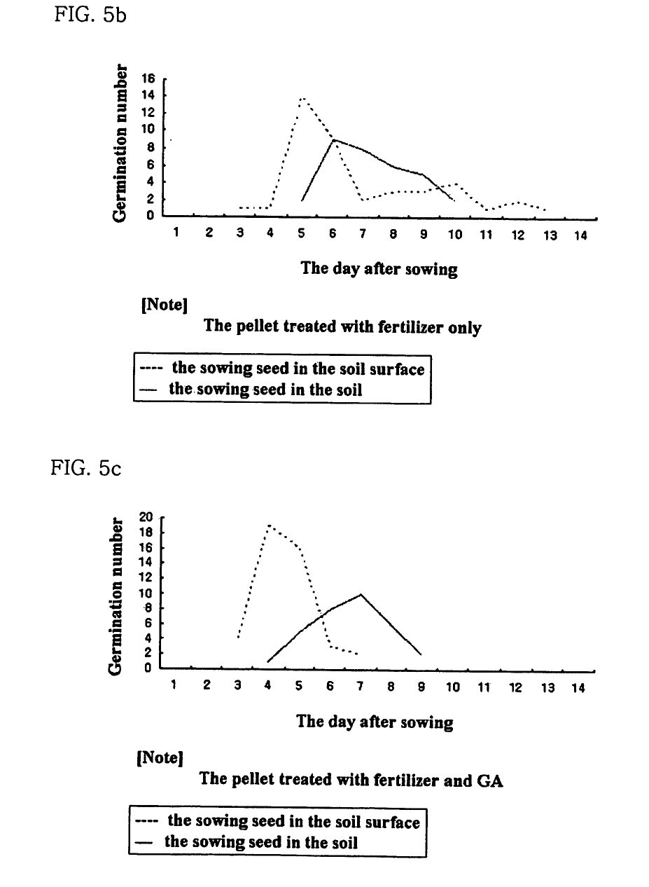

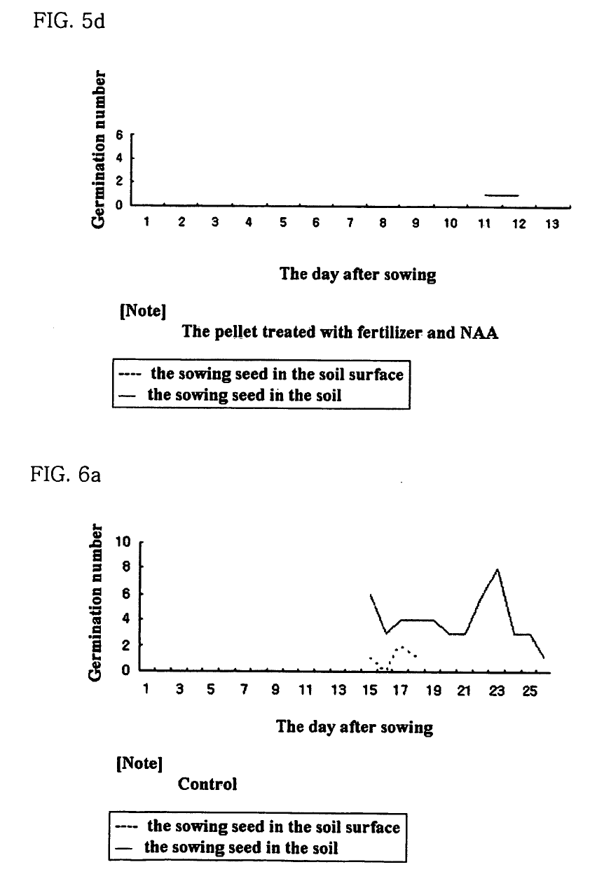

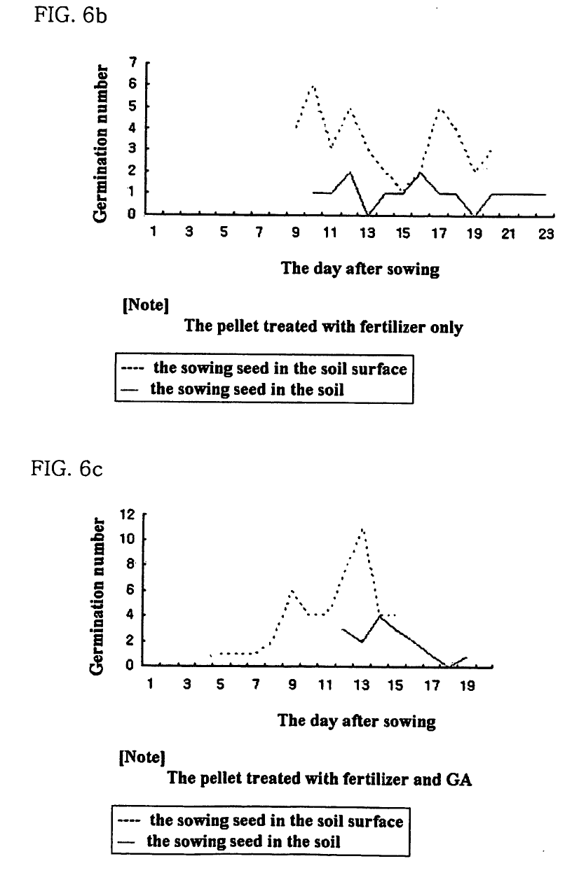

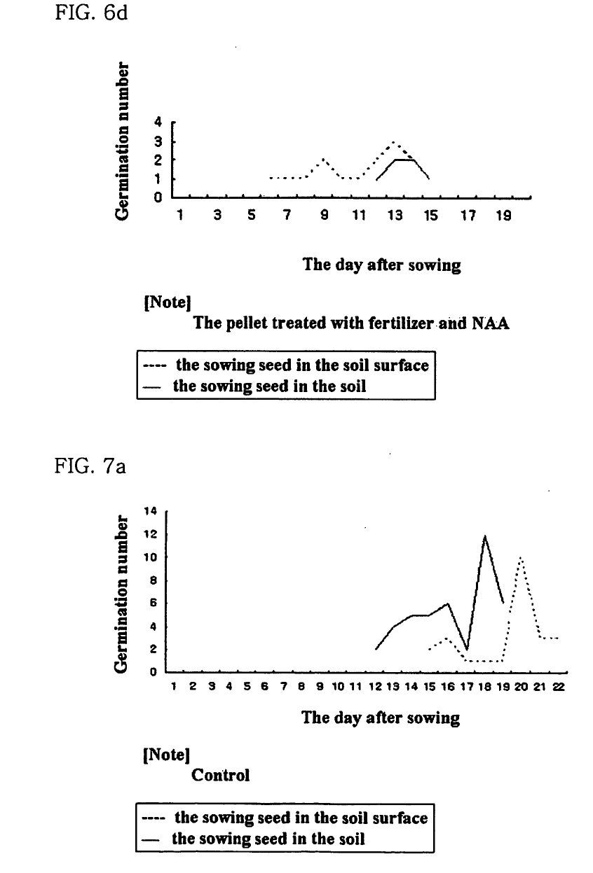

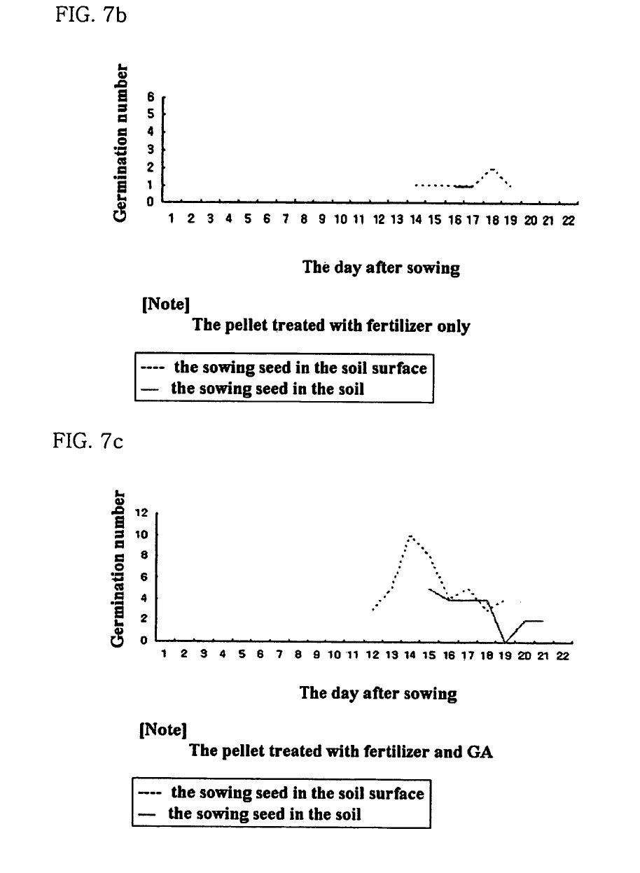

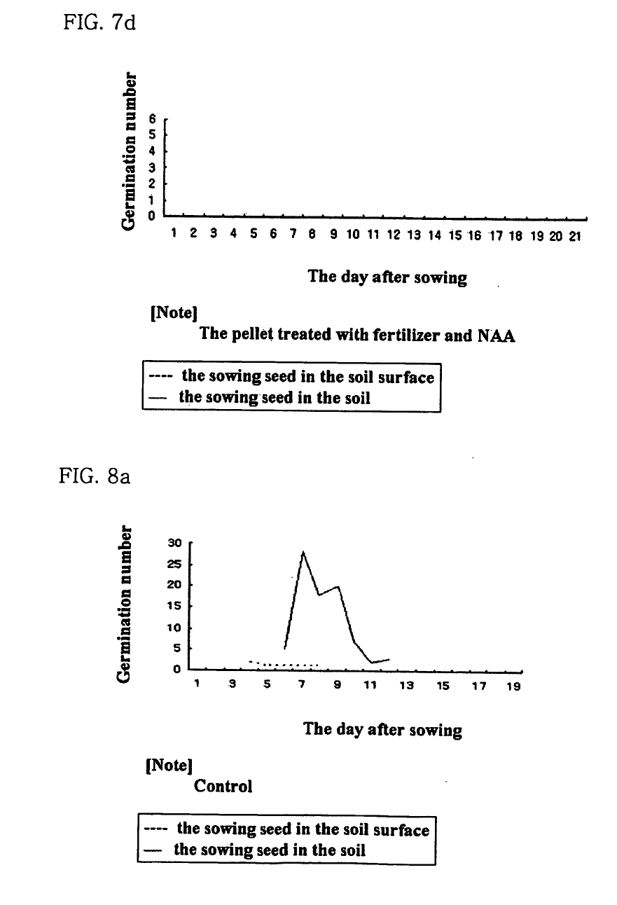

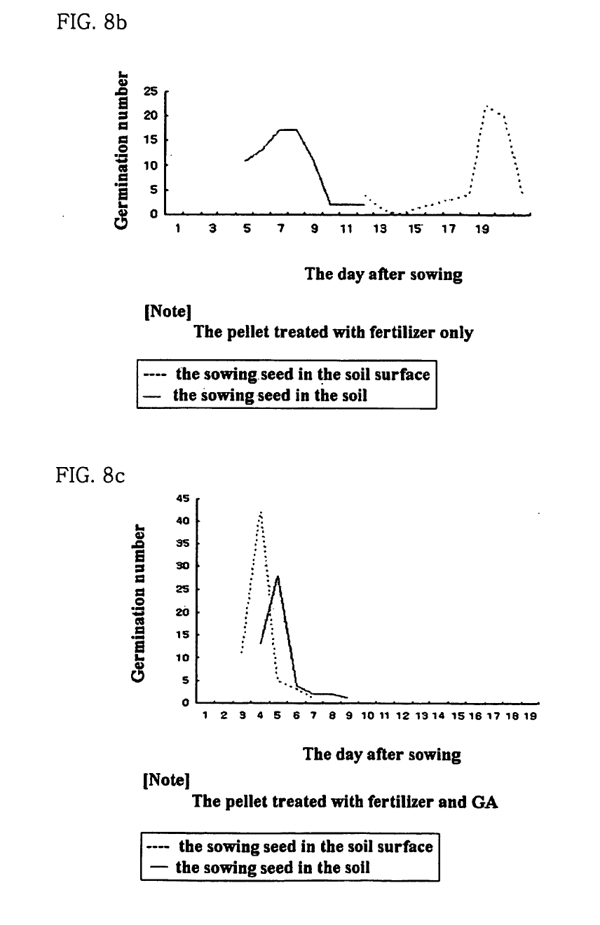

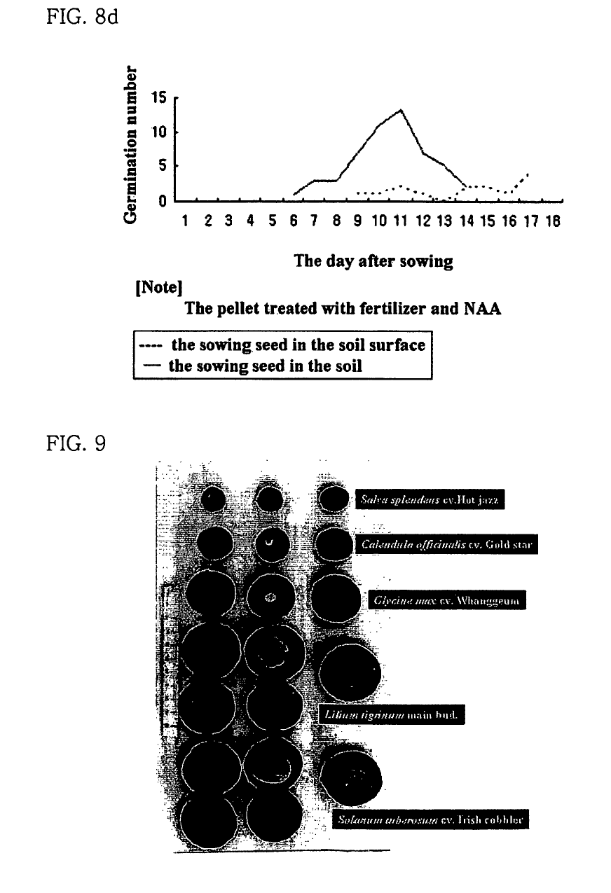

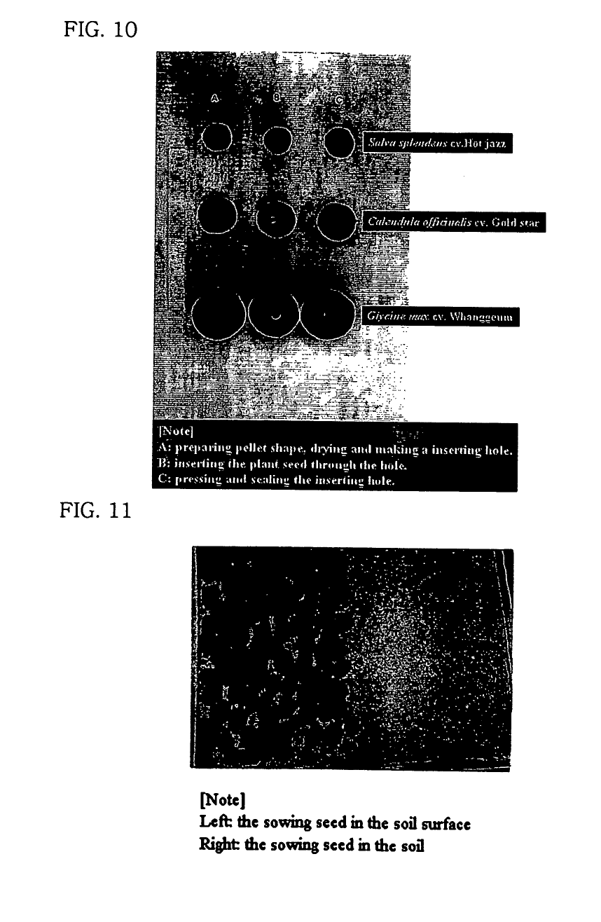

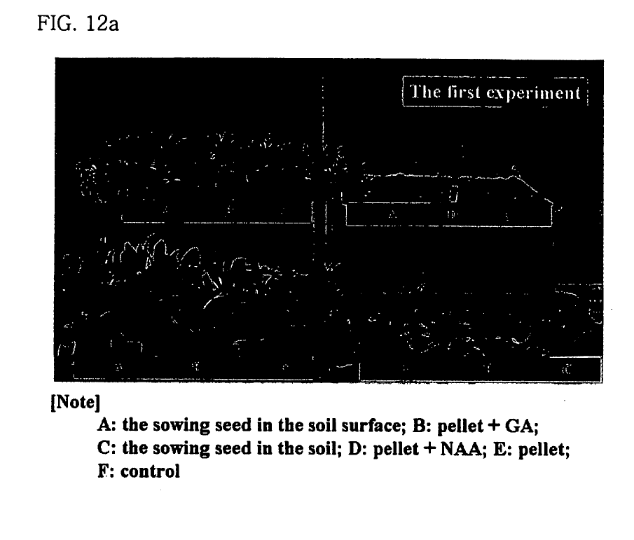

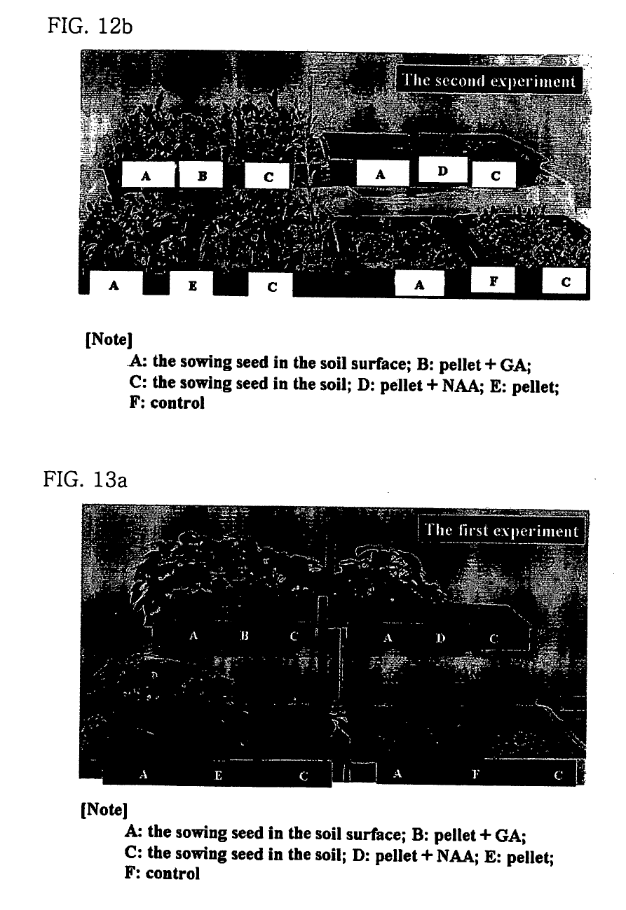

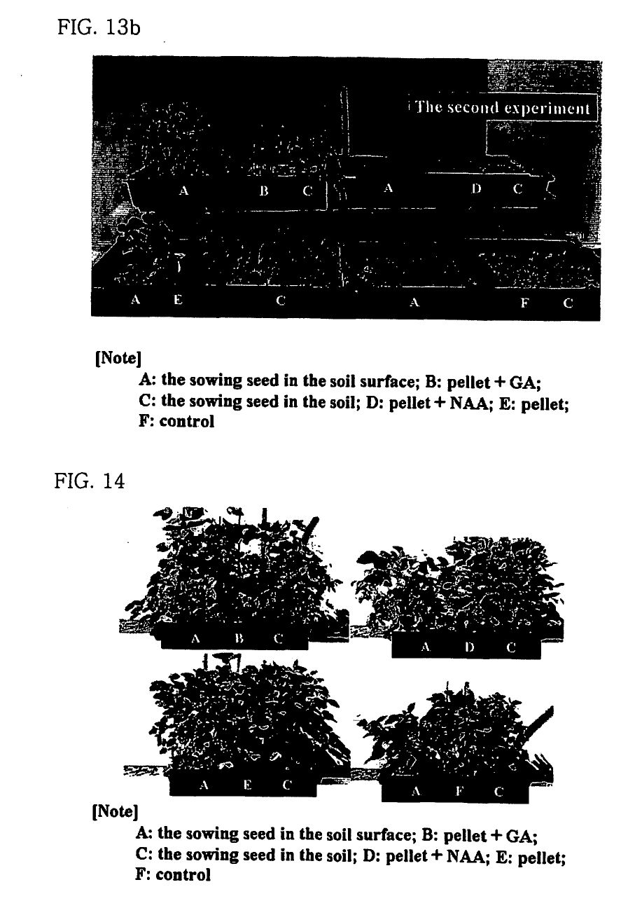

In comparison the growth of the pellet with plant seed of the present invention according to sowing methods, in the cases of the pellets of Calendula officinalis cv. Gold star seed and Salvia splendens cv. Hot jazz seed, the state of growth of those seeds sown in the soil surface (Example 1˜4) was more excellent than the seeds all sown in the soil ithe respects (Table 3, 4, 5). The state of growth of Glycine max cv. Whanggeum seed was similar according to sowing methods; the reason is thought as an effect by supply of nitrogen ingredient carried out by leguminous bacteria in a root of bean (Table 5). In the treatment of sowing seed in the soil surface, the germination rate was high (FIG. 1, 2, 3) and a germinating day was quick (FIG. 5, 6, 7, 8). The reason of said characteristics is that the peatmoss surrounding the pellet of plant seed sown in the soil surface substitutes for soil sufficiently, as a result of that, the plant seed is germinated normally as if it were in the soil.

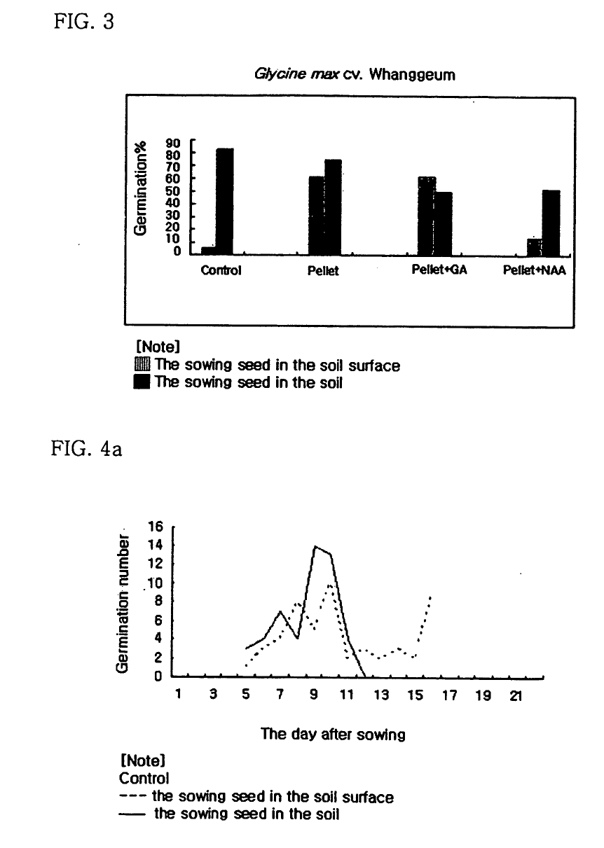

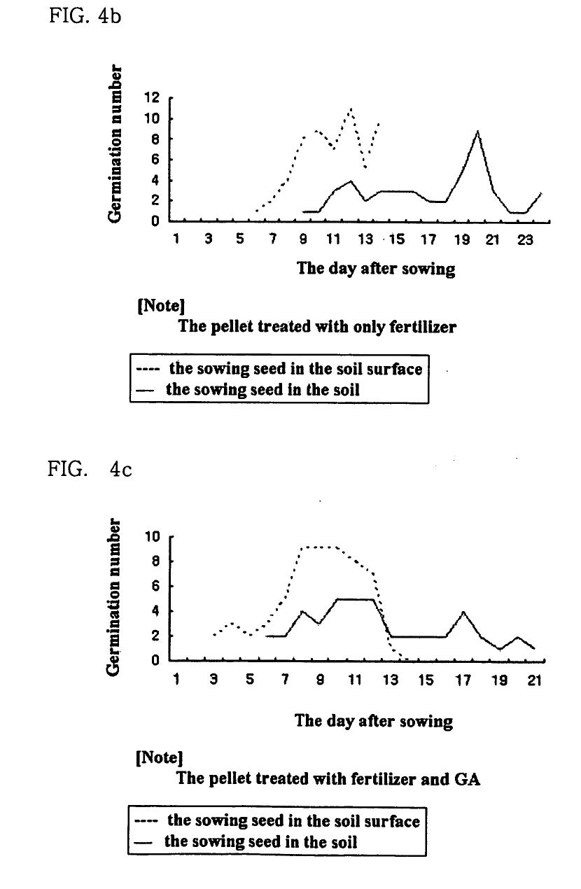

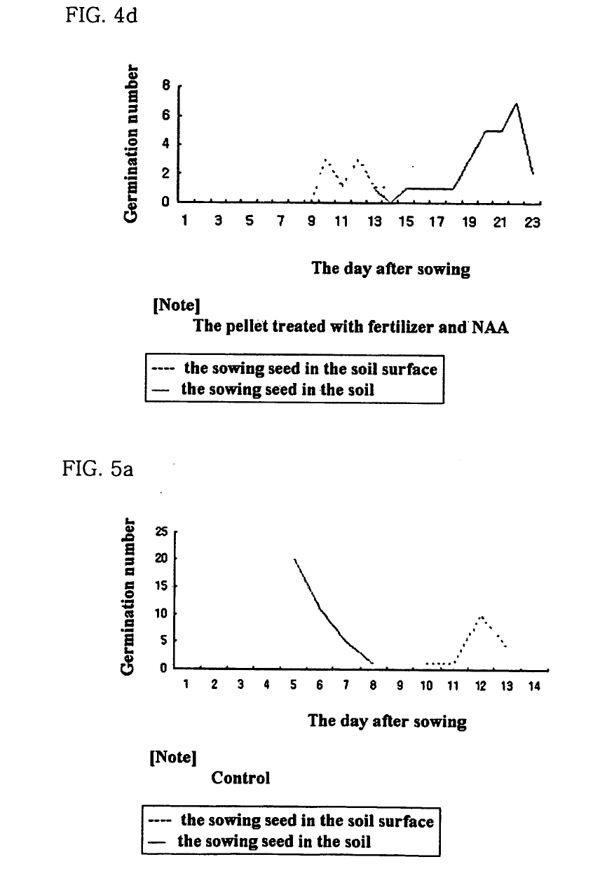

In comparison the growth of the present invention according to plant growth regulators treated with seeds, in the cases of the pellets of Calendula officinalis cv. Gold star seed and Salvia splendens cv. Hot jazz seed, the growth state of the seeds treated with GA was more excellent than the plants treated with NAA (Table 3, 4). In the case of the pellet of Glycine max cv. Whanggeum, the plant height of the seeds treated with GA, which had been sown in the soil surface was five times as long as that of seeds treated with NAA and said result showed a complete physiological characteristic of GA. In the sowing seed in the soil, some seeds treated with NAA had more excellent results but the reason of said results is thought as the effect of leguminous bacteria (Table 5). Also, in the germination number, the pellets of Calendula officinalis cv. Gold star seed and Salvia splendens cv. Hot jazz seed were that the seeds treated with GA had a higher number than the seeds treated with NAA (FIG. 1, 2). However, the pellet of Glycine max cv. Whanggeum seed showed a similar result compared with the case of sowing seed in the soil between the seed treated with GA and the seed treated with NAA (FIG. 3). The germinating day of the pellet of Glycine max cv. Whanggeum seed showed a similar tendency to the germination number (FIG. 1, 2, 3). Said results indicat9XGA causes a diapauses breaking of plant seed, the germination, stem growth and flowering and NAA causes a rooting reaction.

In said examples, the pellet added fertilizer and the pellet added fertilizer and GA showed far excellent growth states and the facts mentioned above are thought on account of fertilizing ingredients mixed with the pellet and a supply of GA. The present invention, the sowing method of the pellet of plant seed is effective when it is carried out in the soil surface and in the case of Glycine max cv. Whanggeum seed, the sowing seed in the soil is effective.

In synthesis of the results mentioned above, the pelletization of plant seed according to the present invention improved the growths of seed comprising germination rate, germination after planting and germinating day etc. than the control, the sowing method in the soil surface was effective than the sowing method in the soil and GA as plant growth regulator resulted in an excellent growth. Therefore, a superiority of the present invention is proved by said results.

### INDUSTRIAL APPLICABILITY

As explanations mentioned hereinabove, the pelletization method of plant seed according to the present invention by mixing materials consisting of fertilizer, plant growth regulator with peatmoss, drying said mixture and inserting the plant seed into it, has no problem by chemical reaction in said process. And the pellet with plant seed prepared by said method prevents physiological reaction of seed from removal of water within a pellet, therefore the growth of plant after germination is remarkably excellent. In addition, the present invention can be used for bulbous plants and makes a large-scale Air sowing possible because the germination rate of the pelletized seed is high without covering with earth again after sowing seed in a soil surface. Therefore, the present invention is a distinguished invention in industries comprising agriculture and gardening.

What is claimed is:

1. A pelletization method of plant seed comprising the steps of:
a) mixing one or more selected from the group consisting of fertilizer, plant growth regulator, bactericide and insecticide with peatmoss using water-soluble glue;
b) forming a mixture of a) step to insert a plant seed in that;
c) drying the mixture formed from b) step; and
d) making a hole to said dried mixture, inserting the plant seed into it, pressing and sealing them and obtaining the resulted pellet with plant seed inserted.

2. The pelletization method of claim 1 in which the plant seed is any one of selected from the group consisting of Calendula officinalis cv. Gold star seed, Salvia splendens cv. Hot jazz seed and Glycine max cv. Whanggeum seed.

3. A pellet with plant seed prepared by a method comprising the steps of:
a) mixing one or more selected from the group consisting of fertilizer, plant growth regulator, bactericide and insecticide with peatmoss using water-soluble glue;
b) forming a mixture of a) step to insert a plant seed in that;
c) drying the mixture formed from b) step; and
d) making a hole to said dried mixture, inserting the plant seed into it, pressing and sealing them and obtaining the resulted pellet with plant seed inserted in.

4. A cultivation method of plant using a pellet with plant seed by sowing and germinating the same, characterizes in which prepared by a method comprising the steps of:
a) mixing one or more selected from the group consisting of fertilizer, plant growth regulator, bactericide and insecticide with peatmoss using water-soluble glue;
b) forming a mixture of a) step to insert a plant seed in that;
c) drying the mixture formed from b) step; and
d) making a hole to said dried mixture, inserting the plant seed into it, pressing and sealing them and obtaining the resulted pellet with plant seed inserted.

5. The cultivation method of plant of claim 4, in which it is treated in the soil surface without covering earth again after sowing.
